(19) United States
(12) Patent Application Publication
(10) Pub. No.: US 2019/0340355 A1
(43) Pub. Date: Nov. 7, 2019

(54) JAVA CARD PLATFORM AND APPLET SECURITY

(71) Applicant: GIESECKE+DEVRIENT MOBILE SECURITY GMBH, München (DE)

(72) Inventors: Deepen MANTRI, München (DE); Oliver GIBIS, München (DE)

(21) Appl. No.: 16/349,444

(22) PCT Filed: Nov. 14, 2017
(86) PCT No.: PCT/EP2017/001332

§ 371 Date: May 13, 2019

(30) Foreign Application Priority Data
Nov. 14, 2016 (EP) 16002408.9

(51) Int. Cl. G06F 21/55; G06F 21/56; G06F 9/54

(52) U.S. Cl. CPC G06F 21/554; G06F 9/54; G06F 21/561

(57) ABSTRACT

An embedded device incorporates Java Card technology including a Java Card platform and at least one applet, and including both platform security features and applet security features. The device has a) a threat detection means to detect events of threat occurring at the embedded device; and b) an interface means constructed to receive a threat notification on a detected event of threat; and establish or use a communication channel between the platform and the applet and exchange threat information on the detected event of threat between the platform and the applet.

### FIELD OF THE INVENTION

The present invention relates to Java Card platform based embedded devices such as smart card processor devices of either smart card form factor or other form factor than card, particularly SIM cards (SIM=subscriber identity module), embedded SIMs, payment cards, identity cards, all of them incorporation a Java Card platform.

### BACKGROUND OF THE INVENTION

Embedded devices hold a runtime environment that can be run on the device, and applets that provide to a user of the device applet specific services. E.g. payment applets provide payment services, SIM applets provide mobile network specific services, identity applets provide identity services, etc.

A Java Card applet is installed into a Java Card embedded device in that a Java Card CAP file—containing applet code and further contents required for applet installation—is loaded into the device, and subsequently the content of the CAP file is proceeded in the device so as to instantiate in the device an applet instance.

Embedded devices are susceptible to various hardware attacks such as light attacks wherein operation of a processor is perturbed by a light flash, resulting in malfunctions such as erroneous jumps in program execution flow, skipping of program code commands or skipping of program counters to forbidden memory areas. This also holds for embedded devices having a Java card platform underlying.

The Java Card platform provides a variety of operating system specific security features effective against hardware attacks. One known feature is to insert redundancy to ascertain data integrity. Herein, some software code parts or some operations are executed two or several times, and the results of the two or several executions are compared. As an indicator of data integrity, equal results are expected in case of no hardware attack occurring. Further regular operation of the device is allowed only if the two or several results are equal. In case the results differ, a data integrity error is assumed, and further regular operation is prohibited. A further known security feature against hardware attacks is de-synchronization wherein random delays are inserted into the execution flow of software code. A further feature is an applet firewall provided by the JavaCard Platform and separating execution contexts of different applets from each other.

On the other hand, applets provide applet specific security features. One such feature is transaction atomicity so as to assure data integrity on an applet basis. Herein, in a program flow, a result of a transaction is accepted for the further program flow only in the case the entire transaction has been executed. Otherwise a data integrity error due to only partial code execution on applet basis is detected (or assumed), and a previously present result or a standard result is used. A further feature is the inclusion of cryptographic classes that offer cryptographic services such as signature and authentication functions to CAP files and other elements.

Platform and applet security features exists in parallel and rather independently to each other. Hardware attacks can, as was mentioned before, lead to erroneous jumps in program execution flow. This might have an effect that a program counter running in a context of an applet jumps into a different applet's context, thus an applet based effect. The platform may have detected the attack. The applet has no means of being noticed of a hardware attack detected by the Java Card platform, even though a notice of the platform to the applet might make sense. On the other hand, it might make sense that an applet instructs the Java Card platform to enhance platform based security measures upon detection of a jump in program execution flow.

### Objective of the Invention

It is an object of the present invention to provide a means to enhance the overall security features of a Java Card technology embedded device including both platform security features and applet security features.

### SUMMARY OF THE INVENTION

The object of the invention is achieved by an embedded device with the following features, according to claim 1. Embodiments of the invention are presented in dependent claims.

The embedded device of claim 1 incorporates Java Card technology including a Java Card platform and at least one applet, and includes both Java Card platform security features and applet security features. In the device of claim 1, in reaction to a received threat notification, a communication channel between the Java Card platform and the applet is established, or a present channel is used or activated. Via the channel, threat information on the detected event of threat is exchanged between the platform and the applet.

The threat information communication channel enables the Java Card platform and the applet to align their security features with each other and thus to optimize scheduling and use of overall available security features of the device.

Thus, by means of the features of the invention, the overall security features of the embedded device are enhanced.

In detail, the inventive solution is achieved by a threat detection means and an interface means cooperating with each other. The threat detection means is installed with either one or both of the Java Card platform and the applet and is constructed to detect events of threat occurring at the embedded device. The interface means is constructed to receive, from the threat detection means, a threat notification on a detected event of threat. In reaction to a received threat notification, the interface means establishes or takes into operation or operates or otherwise uses a (possibly previously established) communication channel between the Java Card platform and the applet and exchanges threat information on the detected event of threat between the Java Card platform and the applet.

According to embodiments of the invention, said interface means is an Application Programming Interface API, particularly a proprietary API especially established for events of threat, or alternatively a standard API in combination with specific parameter values indicative of events of threat.

Also according to embodiments of the invention, said interface means is an exception mechanism agreed upon between the Java Card platform and the applet.

According to further embodiments of the invention, said communication channel is constructed as either one of: (1) a unidirectional communication channel from the Java Card platform to the applet; (2) a unidirectional communication channel from the applet to the Java Card platform; (3) a bidirectional communication channel between the Java Card platform and the applet.

According to further embodiments of the invention, the threat information exchanged between the Java Card platform and the applet comprises a threat type information indicating a type of the detected event of threat. Particularly, the threat type information may comprise one or several of: a light flash attack detected at the platform, a data integrity error detected at the applet or at the platform, a bytecode jump detected at the applet, an execution flow control error detected at the applet or at the platform.

According to further embodiments of the invention, the threat information exchanged between the Java Card platform and the applet comprises or is accompanied by at least one command including instructions to establish or change security features. The command can be either a command from the Java Card platform to the applet, and can include instructions to establish or change applet security features. Alternatively, the command can be a command from the applet to the Java Card platform, and can include instructions to establish or change Java Card platform security features. By these embodiments, the Java Card platform and the applet can take influence on the security features of the respective other party. Hence, an optimized adaption of both Java Card platform and applet security features, taking into account the other party's security requirements, can be pursued or achieved.

### BRIEF DESCRIPTION OF THE DRAWINGS

Embodiments of the invention will now be described with reference to the accompanying drawings, throughout which like parts are referred to by like references, and in which represents:

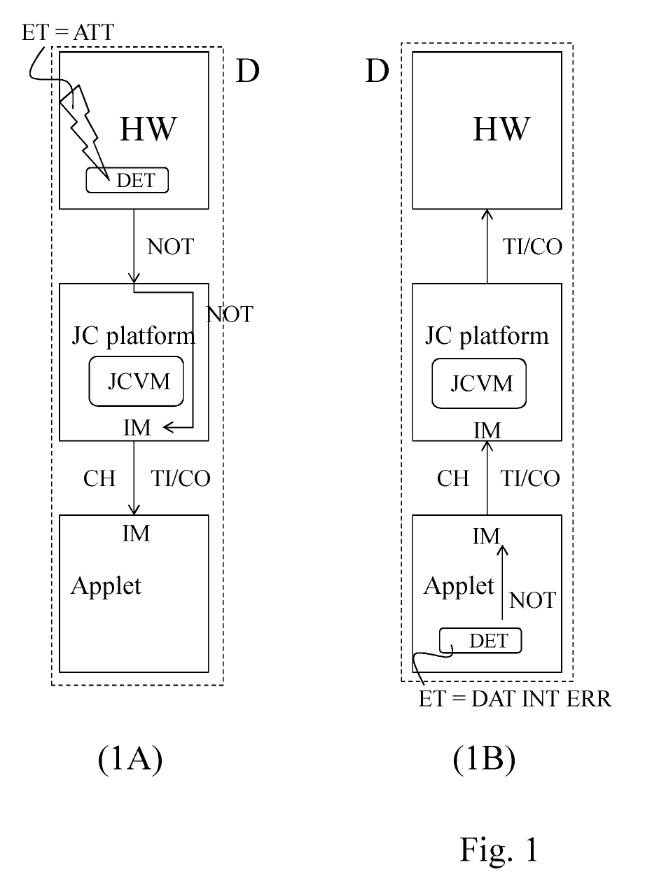

FIG. 1 (A) An embedded device communicating an event of threat via an interface means from a Java Card platform to an applet, according to an embodiment of the invention;
(B) The embedded device of (A) communicating an event of threat via the interface means from the applet to the Java Card platform, according to an embodiment of the invention.

### DETAILED DESCRIPTION OF THE INVENTION

FIG. 1A shows an embedded device D communicating an event of threat ET via an interface means IM from a Java Card JC platform to an applet, according to an embodiment of the invention. The embedded device D comprises a Java Card JC platform including a Java Card Virtual Machine JCVM, hardware HW with which the JC platform can communicate and an applet. The device D can comprise several applets. The hardware HW comprises a threat detection means DET incorporated as a light sensor installed to detect attacks ATT via light flashes and the like. The JC platform and the applet each comprise a respective part of an interface means IM between the JC platform and the applet. The interface means IM can e.g. be an application programming interface API (proprietary or standard in combination with specific parameters) or an exception mechanism.

In the communication event of FIG. 1A, the light sensor DET of the embedded device D detects a light flash attack ATT as an event of threat ET and reports it to the JC platform in a notification NOT. The JC platform internally forwards the notification NOT to the interface means IM. The interface means IM interprets the income of the treat notification NOT as a trigger to build up or activate a communication channel to the corresponding interface means IM part in the applet. Via the communication channel CH, the JC platform sends threat information TI to the applet, comprising for example a threat type or threat reason information that a light attack has occurred and been detected at the device D. The currently active applet instance now has a chance to decide on changing or adapting its own security features, e.g. to activate additional security features. In addition or alternatively, the JC platform can communicate to the applet, via the communication channel CH, commands CO to be executed on the currently active applet instance.

FIG. 1B shows the embedded device of FIG. 1A communicating an event of threat via the interface means from the applet to the Java Card platform, according to an embodiment of the invention. The method of FIG. 1B can be seen independently of that of FIG. 1A or as a complementing method to that of FIG. 1A.

In the communication event of FIG. 1B, a threat detection means DET of the applet, e.g. an integrity check subroutine or method, detects, as an event of threat ET, a data integrity error DAT INT ERR. The data integrity error DAT INT ERR might particularly be a result of a light attack ATT as that of FIG. 1A. The applet sends a notification NOT on the detected event of threat ET to its own interface means IM part. The interface means IM interprets the income of the treat notification NOT as a trigger to build up or activate a communication channel to the corresponding interface means IM part in the JC platform. Via the communication channel CH, the applet sends threat information TI to the JC platform, comprising the information that a light attack has occurred and been detected at the device D. The JC platform now has a chance to decide on changing or adapting its own security features, e.g. to activate additional security features. Particularly, the JC platform can decide to temporarily or permanently change, e.g. upgrade the security level of the currently active applet instance. Further, the applet can send to the JC platform, via the communication channel CH, with the threat information TI, commands CO to be executed on the JC platform, such as halt execution of the currently active applet instance by action of the JC platform, or switch applet execution to a different, safer mode, or switch execution context from currently active applet to error routine, and similar commands CO.

1.-9. (canceled)

10. An embedded device incorporating Java Card technology including a Java Card platform and at least one applet, and including both Java Card platform security features and applet security features, comprising:
a) a threat detection means, installed with either or both of the Java Card platform and the applet, and constructed to detect events of threat occurring at the embedded device; and
wherein
b) an interface means constructed to:
receive, from the threat detection means, a threat notification on a detected event of threat; and,
in reaction to a received threat notification, establish or operate a communication channel between the Java Card platform and the applet and exchange threat information on the detected event of threat between the Java Card platform and the applet.

11. The embedded device according to claim 10, wherein said interface means (IM) is an Application Programming Interface API.

12. The embedded device according to claim 11, wherein said Application Programming Interface API is a proprietary API especially established for events of threat.

13. The embedded device according to claim 11, wherein said Application Programming Interface API is a standard API in combination with specific parameter values indicative of events of threat.

14. The embedded device according to claim 10, wherein said interface means is an exception mechanism agreed upon between the Java Card platform and the applet.

15. The embedded device according to claim 10, wherein said communication channel is constructed as either one of:
(1) a unidirectional communication channel from the Java Card platform to the applet;
(2) a unidirectional communication channel from the applet to the Java Card platform;
(3) a bidirectional communication channel between the Java Card platform and the applet.

16. The embedded device according to claim 10, wherein the threat information exchanged between the Java Card platform and the applet comprises a threat type information indicating a type of the detected event of threat.

17. The embedded device according to claim 16, wherein the threat type information is or comprises one or several of:
a light flash attack detected at the Java Card platform,
a data integrity error detected at the applet or at the Java Card platform,
a bytecode jump detected at the applet,
an execution flow control error detected at the applet or at the Java Card platform.

18. The embedded device according to claim 10, wherein the threat information exchanged between the Java Card platform and the applet comprises or is accompanied by at least one command including instructions to establish or change security features, the command being
either a command from the Java Card platform to the applet, and including instructions to establish or change applet security features,
or a command from the applet to the Java Card platform, and including instructions to establish or change Java Card platform security features.
